(19) United States
(12) Patent Application Publication
(10) Pub. No.: US 2011/0128248 A1
(43) Pub. Date: Jun. 2, 2011

(54) INPUT DETECTION DEVICE, INPUT DETECTION METHOD, PROGRAM, AND STORAGE MEDIUM

(75) Inventors: Jun Nakata, Osaka-shi (JP); Takashi Taneyama, Osaka-shi (JP); Kozo Takahashi, Osaka-shi (JP); Kazuki Takahashi, Osaka-shi (JP); Shigenori Tanaka, Osaka-shi (JP); Kensuke Miyamura, Osaka-shi (JP)

(73) Assignee: SHARP KABUSHIKI KAISHA, Osaka-shi, Osaka (JP)

(21) Appl. No.: 12/994,639

(22) PCT Filed: Apr. 24, 2009
(86) PCT No.: PCT/JP2009/058181

§ 371 Date: Jan. 18, 2011

(30) Foreign Application Priority Data
May 28, 2008 (JP) 2008-140072

(51) Int. Cl. G06F 3/041

(52) U.S. Cl. 345/173

(57) ABSTRACT

An input detection device (1) of the present invention includes: a display (2); a touch panel (3); an input section (4) for detecting a touch made by a user with respect to the touch panel (3); a display section (5) for, while the input section (4) is detecting the touch, (i) causing the display (2) to simultaneously display a plurality of predetermined items (ii) causing the display to simultaneously display one of the plurality of predetermined items in a different display state from those of the other one(s) of the plurality of predetermined items, and (iii) sequentially switching over the one of the plurality of predetermined items, which is displayed in the display state, to another one of the plurality of predetermined items at predetermined intervals so that the another one of the plurality of predetermined items is displayed in the display state; and an item switching section (11) for selecting the one of the plurality of predetermined items, which is displayed in the display state, when the input detection means finishes the detecting of the touch. Therefore, it is possible to provide an input detection device (1) which allows the user to carry out a simple and easy entering operation.

### TECHNICAL FIELD

The present invention relates to: an input detection device including a touch panel; an input detection method; a program; and a storage medium.

### BACKGROUND ART

In recent years, it has become popular for a user to operate, via a touch panel, a car navigation device, a personal digital assistant, or the like.

According to a conventional technique, a plurality of items are selected and displayed on a display screen of the car navigation device or the personal digital assistant. A user selects one of the plurality of items by touching the item on the touch panel, so that a process in accordance with the item thus selected is carried out. FIG. 12 illustrates an example of the conventional technique, in which Display A including Options I through III is displayed on a display screen. For example, in a case where the user selects Option I by touching Option I thus displayed, a process in accordance with Option I is carried out. This causes the display screen to display Display B including Options I-i through I-iii. In a case where the user selects Option I-ii by touching Option I-ii thus displayed, a process in accordance with Option I-ii is carried out. This causes the display screen to display Display C including Options I-ii-1 through I-ii-3. In a case where the user selects Option I-ii-2 by touching Option I-ii-2 thus displayed, a process in accordance with Option I-ii-2 is carried out. This causes the display screen to display Display D.

FIG. 13 specifically shows how the user carries out such an entering operation to search a route, for example. A conventional car navigation device displays, on the display screen, new items related to a selected item (e.g. a start point or a destination point), or other items, such as an intermediate point and a condition for searching a route, every time the user selects an item (e.g. the start point or the destination point) displayed on the display screen, (see FIG. 13). The user is required to carry out the entering operation for every selection of an item.

FIG. 11 is a flow chart showing how a device including a touch panel is operated by the user's entering operation, for example. First, the device determines whether or not the user's entering operation has been carried out with respect to the device (Step S101). When the device accepts the entering operation, the device causes a display screen to display a plurality of options (Step S102). In a case where the user selects one of the plurality of options by carrying out an entering operation, the device carries out a process in accordance with the option thus selected (Step S103). In a case where the process in accordance with the option thus selected is a last process of the selection process, the device finishes the selection process (Step 104). On the other hand, in a case where the process carried out in Step S103 requires a user to select a new item, the display process returns to Step S102.

The device described above, however, requires the user to carry out the entering operation every time new items are displayed on the display screen. That is, the user is required to carry out such an entering operation a lot of times until items for final selection are displayed. It is inconvenient for the user to carry out such an entering operation a plurality of times.

In order to solve the problem, for example, Patent Literature 1 discloses a car navigation system including means for (i) continuously magnifying/reducing a display region of a map, and (ii) when the display region matches a predetermined region in terms of scale, provisionally stopping the magnification/reduction of the display region. In this system, in a case where a button displayed on the touch panel is continuously touched for a predetermined time period, the display region of the map starts to be consecutively magnified/reduced. For example, in order to change a reduction percentage of a displayed map by three stages, it has been conventionally necessary for the user to carry out the entering operation three times. The system disclosed in Patent Literature 1, however, requires the user to carry out the entering operation only once so as to change the reduction percentage by three stages.

Furthermore, Patent Literature 2 discloses another navigation system which allows the user to enter an instruction to magnify/reduce a map into the navigation system in the following manner: (i) the user touches a region to be magnified/reduced with his/her finger, which region is included in the map displayed on a navigation screen, and then (ii) the user moves his/her finger in a direction into which the user desires to magnify/reduce the map.

### CITATION LIST

### Patent Literature 1

Japanese Patent Application Publication, Tokukai, No. 2008-51644 A (Publication Date: Mar. 6, 2008)

### Patent Literature 2

Japanese Patent Application Publication, Tokukai, No. 2003-344059 A (Publication Date: Dec. 3, 2003)

### SUMMARY OF INVENTION

However, in the system disclosed in Patent Literature 1, only one option is displayed on the display screen for each selection. Because of this, the user cannot recognize what options exist other than the option thus displayed. Therefore, in a case where an option that is most suitable for user's demand among the existing options is not being displayed, the user cannot recognize presence of such an option while another option is being displayed. This causes a risk that the user might undesirably select an option which is not most suitable for the user's demand among the existing options.

Further, although the navigation system disclosed in Patent Literature 2 allows the user to change a scale of the map to a predetermined scale by carrying out one entering operation, Patent Literature 2 discloses no method for solving the problem that the user is inconveniently required to (i) select an item from a plurality of items by carrying out the entering operation and (ii) sequentially repeat such a selection (see FIGS. 12 and 13).

The present invention is made in view of the problem. An object of the present invention is to provide an input detection device which allows a user to carry out an entering operation which is simple and easily understood.

In order to attain the object, an input detection device of the present invention, includes: a display; a touch panel; input detection means for detecting a touch made by a user with respect to the touch panel; display means for, while the input detection means is detecting the touch, (i) causing the display to simultaneously display a plurality of predetermined items, (ii) causing the display to simultaneously display one of the plurality of predetermined items in a different display state from those of the other one(s) of the plurality of predetermined items, and (iii) sequentially switching over the one of the plurality of predetermined items, which is displayed in the display state, to another one of the plurality of predetermined items at predetermined intervals so that the another one of the plurality of predetermined items is displayed in the display state; and selection means for selecting the one of the plurality of predetermined items, which is displayed in the display state when the input detection means finishes the detecting of the touch.

According to the arrangement, the input detection device detects a touch made by the user with respect to the touch panel (with a finger or a pen, for example). Here, the display simultaneously displays a plurality of items while the input detection device is detecting the touch made by the user. These items are options one of which is to be selected by the user. The input detection device causes the display to display one of the plurality of items in a different display state from those of the other one(s) of the plurality of items. For example, the one of the plurality of predetermined items is displayed in a certain color, and the other one(s) of the plurality of items is displayed in another color. Alternatively, for example, the one of the plurality of predetermined items is displayed as being circled by a frame, and the other one(s) of the plurality of predetermined items is displayed without being circled by any frame. This allows the user to easily recognize a certain item among the items thus displayed.

Further, the input detection device switches over the item displayed in the display state to another one of the plurality of items at the predetermined intervals. For example, the input detection device causes the display to display a plurality of items, namely, a first item, a second item, and a third item, in such a manner that the first item is displayed in a different display state from those of the second and third items. Then, when a predetermined time period elapses, the input detection device causes the display to display the first, second, and third items in such a manner that the second item is displayed in the display state different from those of the first and third items. By repeating such a process, the input detection device causes the display to sequentially display, in turn, one of the first, second, and third items in the display state different from those of the other two items, among the first, second, and third items.

When the input detection means finishes the detecting of the touch, the input detection device specifies one of the plurality of items, which is being displayed in the display state when the input detection means finishes the detecting of the touch. Then, the input detection device selects the item thus specified.

As described above, the input detection device of the present invention sequentially switches over the item displayed in the display state to another item among the plurality of items. When the target item to be selected is displayed in the display state, the user stops touching the touch panel so as to select the target item. Accordingly, it is possible to reduce the number of times that the user carries out the entering operation, because the user can select the target item without touching the touch panel a plurality of times. Therefore, the user is not annoyed with the entering operation. Further, the user can instantly recognize what items are displayed while the switching process is being carried out. Thus is because, while the switching process is being carried out, (i) the plurality of items are simultaneously displayed in such a manner that one of the plurality items is displayed in a different display state from those of the other one(s) of the plurality of items, and (ii) the one of the plurality of items, which is displayed in the display state, is sequentially switched over to another one of the plurality of items one by one so that the another one of the plurality of items is displayed in the display state.

In the present specification, the user directly touches the touch panel with an object (such as his/her finger or a pen). Note, however, that the present invention is not limited to this. If a user's finger, not touching a surface of the touch panel but being close to the surface, can be detected by any means, such detection would be included in the scope of “touch”.

Further, in order to attain the object, an input detection method of the present invention, executed in an input detection device which includes a display and a touch panel, includes the steps of: (a) detecting a touch made by a user with respect to the touch panel; (b) while the input detection means is detecting the touch, (i) causing the display to simultaneously display a plurality of predetermined items, (ii) causing the display to simultaneously display one of the plurality of predetermined items in a different display state from those of the other one(s) of the plurality of predetermined items, and (iii) sequentially switching over the one of the plurality of predetermined items, which is displayed in the display state, to another one of the plurality of predetermined items at predetermined intervals so that the another one of the plurality of predetermined items is displayed in the display state; and (c) selecting the one of the plurality of predetermined items, which is displayed in the display state when the input detection means finishes the detecting of the touch.

According to the arrangement, the input detection method of the present invention realizes the same effects as those of the input detection device of the present invention.

As described above, the input detection device of the present invention (i) simultaneously displays a plurality of items, (ii) simultaneously displays one of the plurality of items in a different display state from those of the other one(s) of the plurality of items, (iii) sequentially switches over the one of the plurality of items, which is displayed in the display state, to another one of the plurality of items so that the another one of the plurality of items is displayed in the display state, and (iv) selects the one of the plurality of items, which is displayed in the display state, when detecting of a touch, made by a user with respect to the touch panel, is finished. Therefore, the user can instantly recognize what items are displayed, and easily carry out an operation to select an item from the plurality of items thus displayed.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a block diagram illustrating a main part of an input detection device in accordance with an embodiment of the present invention.

FIG. 2 is a flowchart showing how the input detection device of the present invention selects an item.

FIG. 3 is a view illustrating how a user carries out an entering operation on a display by use of a pen, in accordance with the embodiment of the present invention.

FIG. 4 is a view illustrating how the user carries out an entering operation on the display by use of a finger, in accordance with the embodiment of the present invention.

FIG. 5 is a flowchart showing how the input detection device of the present invention selects information in a case where a plurality of points are touched on the display screen.

FIG. 6 is a view illustrating how the user carries out an entering operation by touching two points on the display so as to search a route, in accordance with the embodiment of the present invention.

FIG. 7 is a flowchart showing how the input detection device of the present invention selects a route in a case where the user carries out an entering operation by touching two points on the display, in accordance with the embodiment of the present invention.

FIG. 8 is a view illustrating how the user carries out an entering operation by touching two points on the display so as to search a route, in accordance with another embodiment of the present invention.

FIG. 9 is a view illustrating how the user carries out an entering operation by designating one point displayed on the display, so as to search a route between the point thus designated and a point indicating a current position of the input detection device, in accordance with another embodiment of the input detection of the present invention.

FIG. 10 is a flowchart showing how the input detection device of the present invention selects a route in a case where the user carries out an entering operation by touching one point on the display, in accordance with another embodiment of the input detection device of the present invention.

FIG. 11 is a flowchart showing how an item is selected in accordance with a conventional technique.

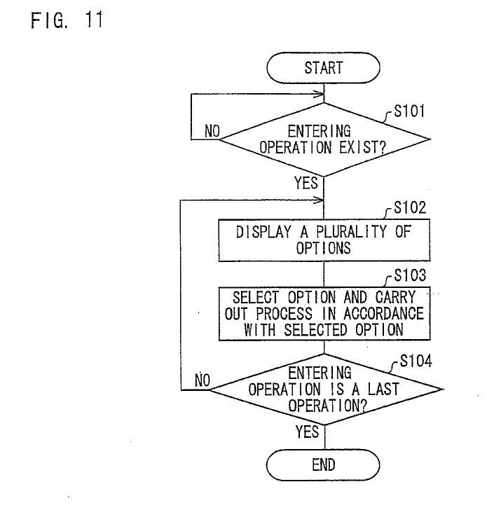

FIG. 12 is a view illustrating how a user carries out an entering operation on a display so as to select an item, in accordance with the conventional technique.

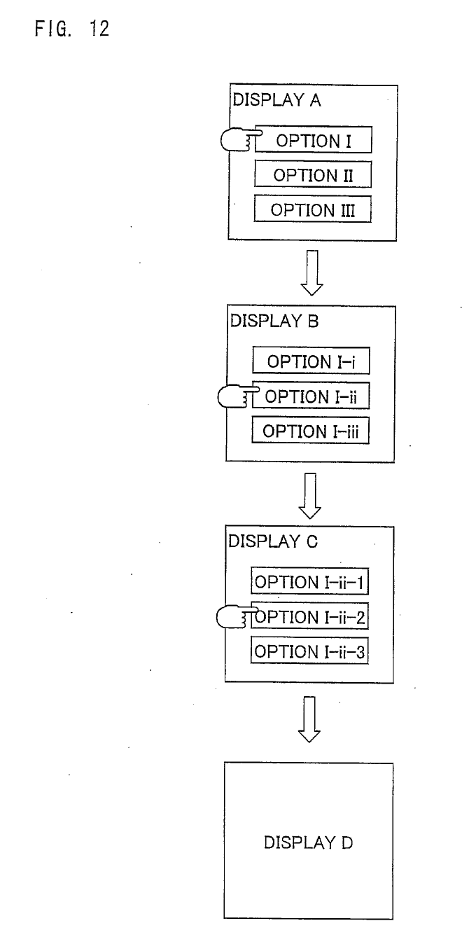

FIG. 13 is a view illustrating how the user carries out the entering operation on the display so as to search a route, in accordance with the conventional technique.

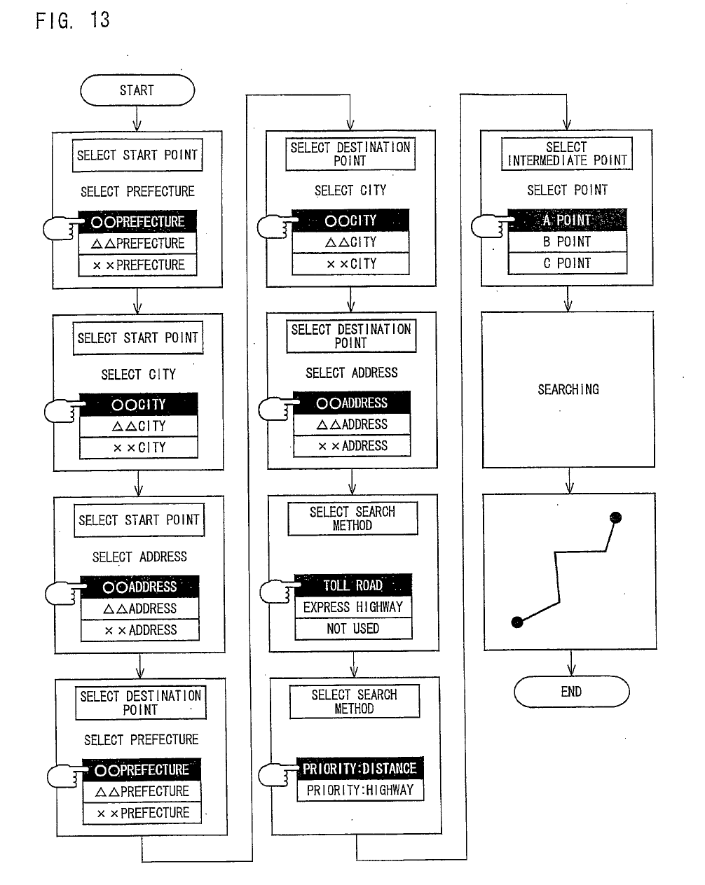

### DESCRIPTION OF EMBODIMENTS

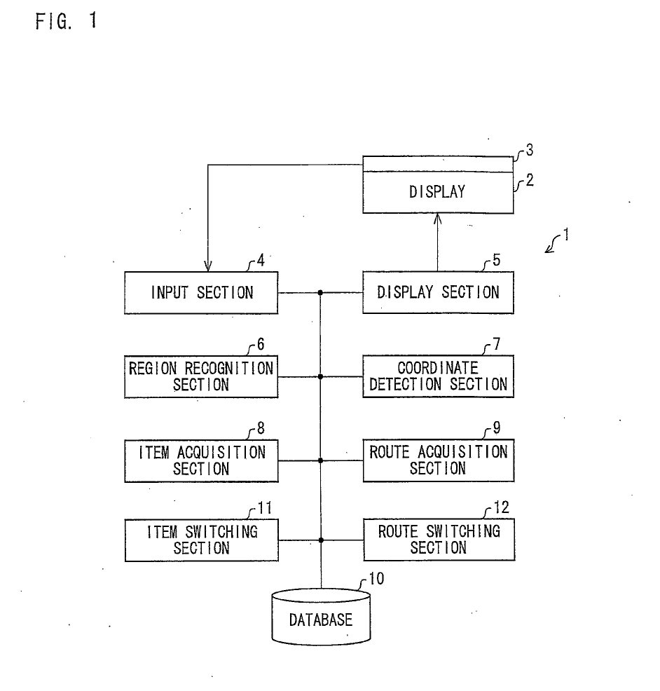

One embodiment of an input detection device of the present invention is described below with reference to FIGS. 1 through 8.

### (Arrangement of Input Detection Device)

First, a main part of the input detection device of the present embodiment is described below with reference to FIG. 1.

FIG. 1 is a block diagram illustrating a main part of an input detection device 1 of the present embodiment. The input detection device 1 includes: a display 2; a touch panel 3; an input section 4 (input detection means, selection means); a display section 5 (display means); a region recognition section 6 (region recognition means); a coordinate detection section 7 (coordinate detection means); an item acquisition section 8; a route acquisition section 9; an item switching section 11; a route switching section 12; and a database 10 (see FIG. 1).

### (Schematic Description as to Each Section)

The input section 4 can accept an input signal which is generated in response to a user's entering operation, which is a touch made with respect to the touch panel 3 with an object, such as a pen or his/her finger. Here, the “object” is a user's finger or a touch pen used by the user, for example.

On the basis of the input signal accepted by the input section 4, the coordinate detection section 7 detects position coordinates on the touch panel 3 where the object touches. The position coordinates can be detected by a conventional method.

On the basis of the input signal accepted by the input section 4, the region recognition section 6 can recognize a position where the touch panel 3 is in contact with the object or an area of a region where the touch panel 3 is in contact with the object.

The item acquisition section 8 obtains, among pieces of data which are, for example, stored in the database 10, a plurality of items in accordance with the position coordinates detected by the coordinate detection section 7. Note here that the items thus obtained can be changed (i) in accordance with a size of the region which is recognized by the region recognition section 6 and (ii) in accordance with the time period, in which the touch panel 3 and the object are in contact with each other, detected by the input section 4.

In a case where (i) the input section 4 accepted a plurality of input signals from the user and (ii) the coordinate detection section 7 detects a plurality of position coordinates of the respective plurality of input signals, the route acquisition section 9 obtains, among the pieces of data stored in the database 10, a plurality of routes determined in accordance with how the plurality of position coordinates are related to one another.

The item switching section 11 selects one of the plurality of items, obtained by the item acquisition section 8, so that the one of the plurality of items is displayed in a display state different from those of the other one(s). Further, the item switching section 11 can switch over the one of the plurality of items to another one of the plurality of items when a predetermined time period elapses.

The route switching section 12 causes one of the plurality of routes, obtained by the route acquisition section 9, to be in a selected state. Further, the route switching section 12 switches over the one of the plurality of routes to another one of the plurality of routes when a predetermined time period elapses.

The display section 5 causes the display 2 to display various image information and text information. The display 2 can be exemplified by, but not limited to, a liquid crystal display. Note that another sort of display screen can be used as the display 2. The “information” contains: the plurality of items obtained by the item acquisition section 8; and course information indicating the plurality of routes (courses) obtained by the route acquisition section 9.

The plurality of items, the route information, and map information are stored in the database 10. The database 10 has storage means, such as a hard disk, a flash memory, or an RAM. Alternatively, such information can be stored in a server device on the Internet. In this case, the input detection device 1 may further include a communication device so as to communicate with the server device on the Internet.

The touch panel 3 can be exemplified by a conventional touch panel, such as a resistive touch panel, an electromagnetic induction touch panel, a capacitive touch panel, an infrared touch panel, or a photo-detection touch panel. Among these, the photo-detection touch panel is preferable in terms of accuracy in coordination recognition and applicability to entering of a plurality of points. The photo-detection touch panel is a touch panel in which a photodetector is provided, and which can recognize input information, entered by the user, by detecting an amount of incident light on the touch panel.

(Selection Process Carried Out with Single Input Point)

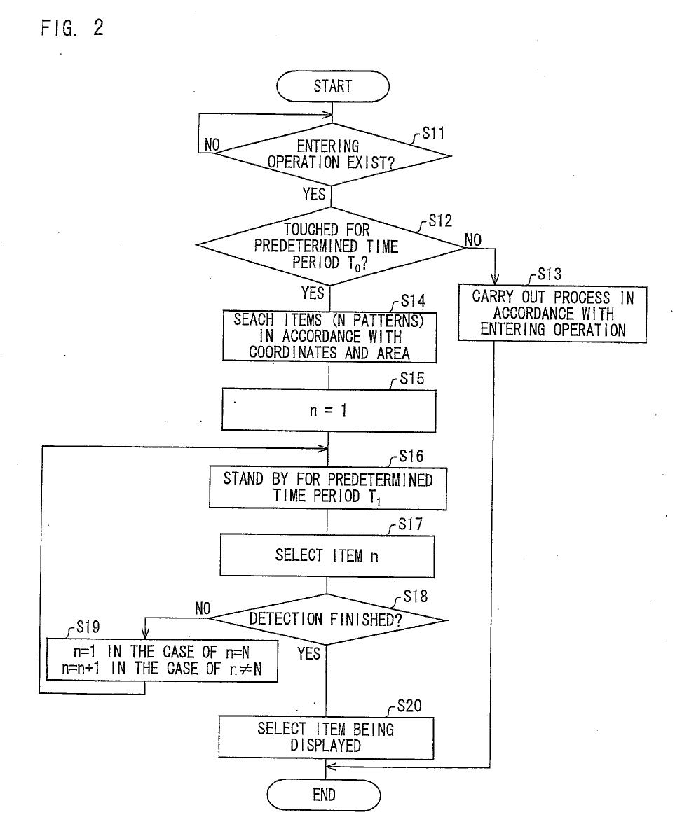

The following description deals with how the input detection device 1 carries out processes, with reference to FIG. 2. FIG. 2 is a flowchart showing how the input detection device 1 carries out the processes.

First, the input section 4 accepts an input signal from the touch panel 3, which input signal is generated in response to the user's entering operation (in response to a touch made by the user with respect to the touch panel) (Step S11). The input section 4 supplies the input signal thus accepted to the coordinate detection section. On the basis of the input signal supplied from the input section 4, the coordinate detection section 7 detects position coordinates of a position on the touch panel 3 where the user's entering operation has been carried out.

Here, the “user's entering operation” means that the user touches the touch panel 3 with an object, such as a pen or his/her finger, or the user detaches such an object from the touch panel 3. Further, the “position on the touch panel 3 where the user's entering operation has been carried out” means a position on the touch panel 3 where the user has touched with the object such as the pen or his/her finger.

The input section 4 determines whether or not the object is in contact with the touch panel 3 for a predetermined time period T₀ or longer (Step S12). In a case where the time period during which the object is in contact with the touch panel 3 is less than the predetermined time period T₀, the input section 4 determines that the entering operation is a normal operation. In this case, the input detection device 1 carries out a process in accordance with the entering operation (Step S13).

On the other hand, in a case where the input section 4 determines that the object is in contact with the touch panel 3 for the predetermined time period T₀ or longer, the item acquisition section 8 obtains, among the data stored in the database 10, N items in accordance with the position coordinates detected by the coordinate detection section 7 (Step S14). The item switching section 11 turns one of the N items into a selected state (Step S15). The display section 5 causes the display 2 to simultaneously display the N items so that the user can recognize one of the N items, which is in the selected state. After that, the input detection device 1 becomes in a standby state until a predetermined time period T₁ elapses (Step S16). After the predetermined time period T₁ elapses, the item switching section 11 selects, as an item to be entered, one of the N items to be in the selected state (Step S17). Next, the item switching section 11 determines whether or not the input section 4 has accepted, from the user, an entering operation causing an end of the selection (Step S18). In a case where the item switching section 11 determines that the input section 4 has accepted the entering operation causing the end of the selection, the item switching section 11 terminates the selection operation. When the selection operation is terminated, the one of the N items, which (i) is in the selected state at that time and (ii) has been selected as the item to be entered, is ultimately selected as the input information (Step S20). In a case where the item switching section 11 determines in Step S18 that the input section 4 has accepted no entering operation causing the end of the selection, the item switching section 11 switches over the one of the N items to another one of the N items (Step S19). Then, the input detection device 1 becomes in the standby state again until the predetermined time period T₁ elapses. After that, the item switching section 11 determines whether or not the input section 4 has accepted the entering operation causing the end of the selection.

Thus, the item switching section 11 sequentially switches over from one item which is in the selected state to another item until the input section 4 accepts, from the user, the entering operation causing the end of the selection. After (i) each of the N items is sequentially turned into the selected state one by one, and (ii) for each of the N items sequentially turned into the selected state, the input detection device 1 is in the standby state until a predetermined time period T₁ elapses, the process returns to the initial step (S11), and is repeated.

(How Input Detection Device Operates when a Single Input Point is Entered)

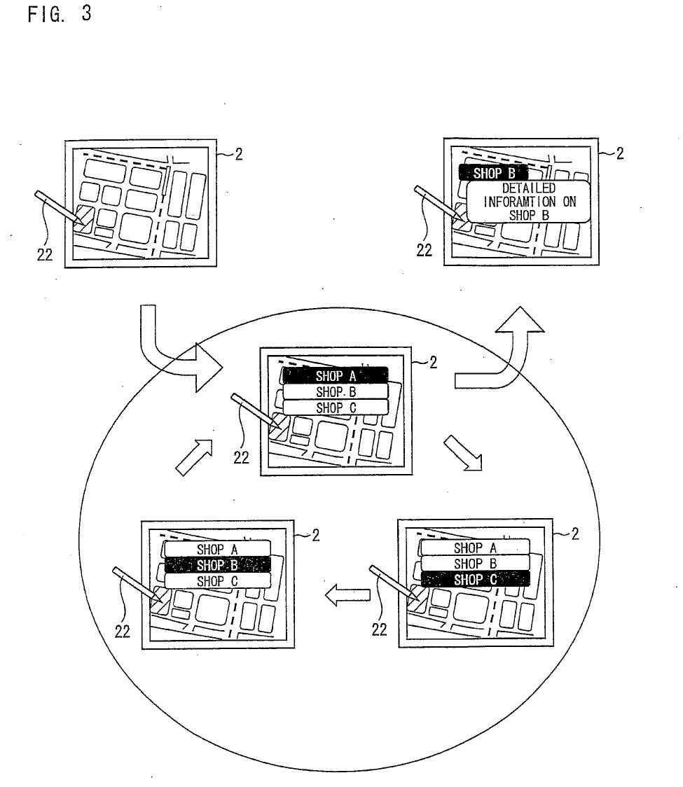

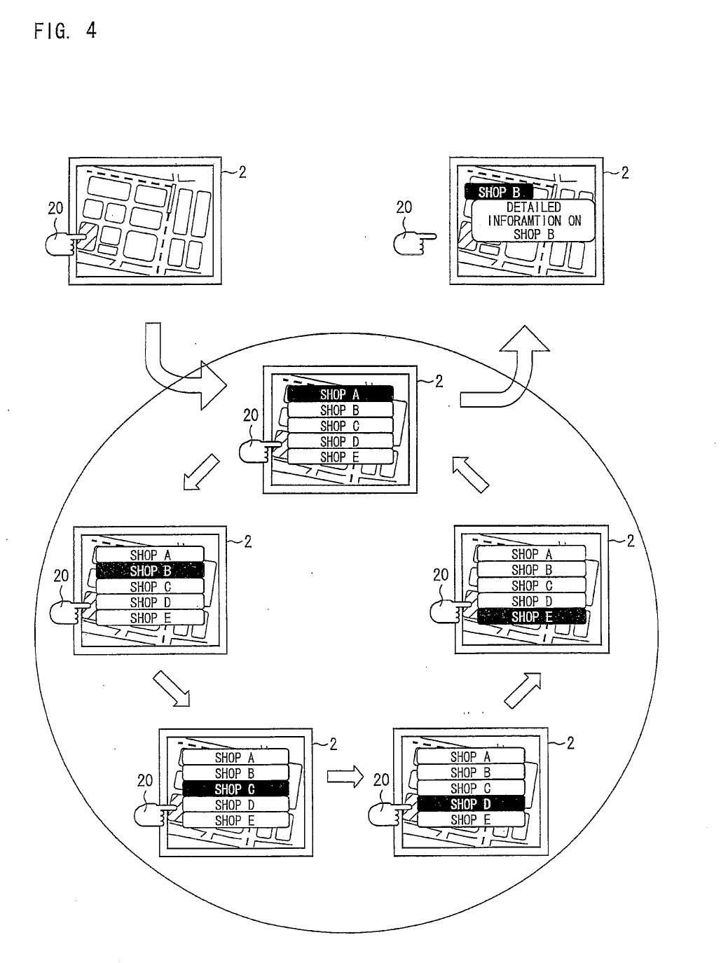

Next, the following description deals with how the input detection device 1 is operated in accordance with an embodiment, with reference to FIGS. 3 and 4.

FIG. 3 illustrates how (i) images are displayed on the display screen 2 and (ii) the user carries out the entering operation, while the input detection device 1 is carrying out the process shown in FIG. 2. In the present embodiment, the user carries out the entering operation by touching the touch panel 3 with a pen (object) 22.

In a case where the user has touched the touch panel 3 with the pen 22 for a predetermined time period T₀ or longer, the display screen 2 displays a plurality of items (Shops A, B, and C) in accordance with a position where the pen 22 has touched (see FIG. 3). At this time, one of the plurality of items thus displayed is in the selected state (Shop A, for example). Here, the “selected state” means a display state which is different from those of the others of the plurality of items. The user can recognize which one of the plurality of items is in the selected state, for example, by causing an item, which is in the selected state, to be displayed (i) in a color different from or (ii) in a state reverse to those of the others of the plurality of items.

In a case where the pen 22 and the touch panel 3 have been in contact with each other for the predetermined time period T₁, the item which is in the selected state is switched over from Shop A to Shop C. In a case where the pen 22 and the touch panel 3 have been in contact with each other for another predetermined time period T₁, the item which is in the selected state is switched over from Shop C to Shop B. In a case where the pen 22 and the touch panel 3 have been in contact with each other for a further predetermined time period T₁, the item which is in the selected state is switched over from Shop B to Shop A. The switchovers are repeated until the user detaches the pen 22 from the touch panel 3. Under the circumstances, for example, in the case where the user detaches the pen 22 from the touch panel 3 while Shop B is in the selected state, Shop B is ultimately selected as the input information. As a result, a process is carried out in accordance with the input information thus selected. For example, detailed information as to Shop B is displayed on the display 2.

In the present embodiment, the pen 22 and the touch panel 3 have been in contact with each other from a time when the user causes the input detection device 1 to start the selection process by keeping the touching of the touch panel 3 with the pen 22 for the predetermined time period T₀ or longer to a time when the user ultimately specifies the item to be selected. That is, the input detection device 1 continues carrying out the switchover process while the pen 22 and the touch panel 3 are in contact with each other. And, when the user detaches the pen 22 from the touch panel 3 so that the pen 22 and the touch panel 3 are no longer in contact with each other, the input detection device 1 suspends the switchover process. Note, however, that the present embodiment is not limited to this. For example, the switchover process can be continuously carried out even in a case where the user detaches the pen 22 from the touch panel 3 after the user causes the input detection device 1 to start the selection process by causing the touch panel 3 to be in contact with the pen 22 for the predetermined time period T₀ or longer. In this case, when the user touches the touch panel 3 again as the entering operation causing the end of selection while a target item is displayed in the selected state on the display 2, the user can select the target item as the input information. Note here that a position, on the touch panel 3 where the user touches as the entering operation causing the end of the selection, is not limited to the position where the target item to be selected is displayed. The user can carry out such an entering operation by touching anywhere on the touch panel 3.

(Displaying Items in Accordance with Area of Contact Region)

FIG. 4 illustrates a case where the user carries out the entering operation illustrated in FIG. 3 by use of, for example, a finger 20 in place of the pen 22. In this case, the region where the finger 20 and the touch panel 3 are in contact with each other is larger than the region where the pen 22 and the touch panel 3 are in contact with each other. Note, here, that the following description deals with only a difference between the entering operation carried out by use of the finger 20 and the entering operation carried out by use of the pen 22.

In the case where the user touches the point illustrated in FIG. 3 with the pen 22, three items (Shops A, B, and C) are displayed. On the other hand, in a case where the user touches the same point with the finger 20 in place of the pen 22, five items (Shops A, B, C, D, and E) are displayed (see FIG. 4). An item to be in the selected state is switched over from Shop A to another of the five items sequentially one by one, while the finger 20 and the touch panel 3 are in contact with each other. The switchover process is repeated until the user detaches the finger 20 from the touch panel 3. Here, the following description deals with how the input detection device 1 carries out the switchover process.

In a case where the input section 4 accepts the input signal from the touch panel 3, the coordinate detection section 7 detects position coordinates of a region where the object, such as the pen or the user's finger, and the touch panel 3 are in contact with each other. Simultaneously, the region recognition section 6 detects the size of the region where the object, such as the pen or the user's finger, and the touch panel 3 are in contact with each other. In a case where the region is smaller than a predetermined area (e.g. in a case where the touch panel 3 is touched with a sharp-pointed pen so that the region where the touch panel 3 and the object are in contact with each other is small), the item acquisition section 8 obtains a plurality of items on the basis of the position coordinates detected by the coordinate detection section 7. In contrast, in a case where the area of such a region is equal to or larger than the predetermined area (e.g. in a case where the touch panel 3 is touched by the finger so that the region where the touch panel 3 and the finger are in contact with each other is larger than the region where the touch panel 3 and the pen are in contact with each other), the item acquisition section 8 obtains a plurality of items on the basis of (i) the position coordinates detected by the coordinate detection section 7 and (ii) neighborhood position coordinates. Position coordinates which are located in a predetermined range can be employed as the neighborhood position coordinates. Alternatively, the neighborhood position coordinates can be determined in accordance with the size of the region where the touch panel 3 and the object are in contact with each other. The item acquisition section 8 can thus obtain a plurality of items in accordance with the size of the region recognized by the region recognition section 6.

(How Input Detection Device Operates when a Plurality of Input Points are Entered)

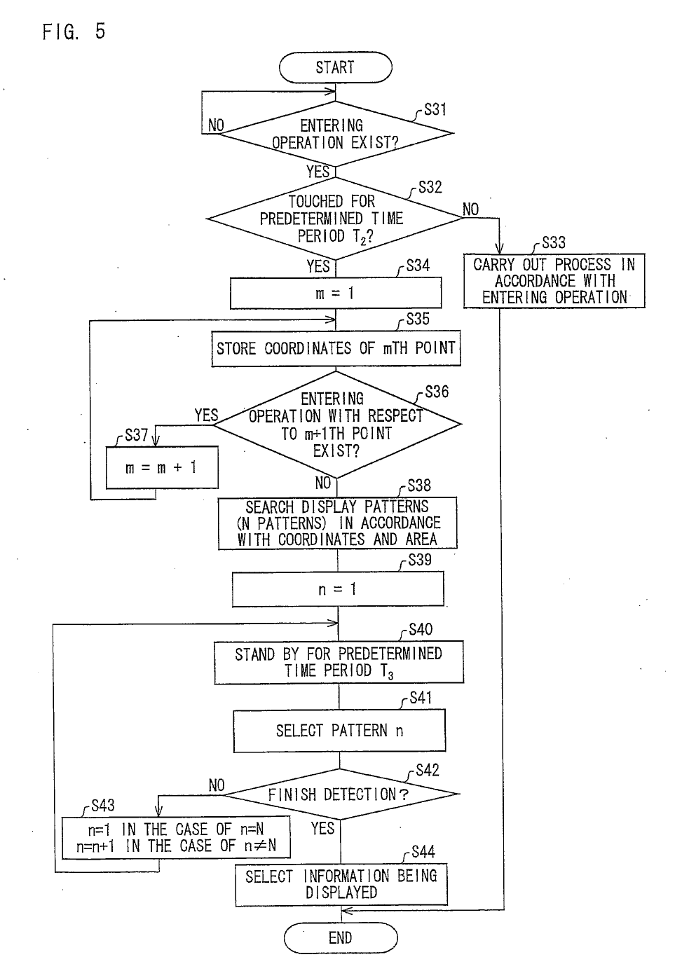

Next, the following description deals with a case where the user touches a plurality of points on the touch panel 3, with reference to FIGS. 5 through 8.

FIG. 5 is a flowchart showing how the input detection device 1 is operated in a case where the user enters a plurality of input points. The following description deals with Steps S31 through S44 with reference to FIG. 5.

The input section 4 accepts input signals from the touch panel, which input signals are generated in response to the user's entering operation (Step S31). The input section 4 determines whether or not the objects and the touch panel 3 have been in contact with each other for a predetermined time period T₂ or longer (Step S32). In a case where the input section 4 determines that the time period during which the objects and the touch panel 3 have been in contact with each other is less than the predetermined time period T₂, the input section 4 determines the entering operation as a normal entering operation. In this case, the input detection device 1 carries out a process in accordance with the entering operation (Step S33).

On the other hand, in a case where the input section 4 determines that the objects and the touch panel 3 have been in contact with each other for the predetermined time period T₂ or longer, the coordinate detection section 7 selects, as a first input point, one of a plurality of positions on the touch panel 3 where the object, such as the pen or the user's finger, touches (Step S34). An input point, whose time period during which the user touches the touch panel 3 becomes longer first than the predetermined time period T₂, can be selected as the first input point, for example. The coordinate detection section 7 detects and stores position coordinates of the first input point thus selected (Step S35). Then, the coordinate detection section 7 determines whether or not there is any input point(s) other than the first input point which has been already detected (Step S36). In a case where the coordinate detection section 7 determines that there is such any input point(s), the coordinate detection section 7 selects one of them (Step S37). After that, the coordinate detection section 7 detects and stores position coordinates of the one thus selected (Step S35). Then, the coordinate detection section 7 determines whether or not there is still any other input point(s). By repeating this process, the coordinate detection section 7 stores position coordinates of all of the plurality of input points.

Next, by use of a predetermined algorithm, the route acquisition section 9 obtains, from the pieces of data stored in the database 10, a plurality of patterns (N patterns) on the basis of a relationship between the plurality of position coordinates thus stored (Step S38). The route switching section 12 causes one of the plurality of patterns to be in the selected state (Step S39). The display section 5 causes the display 2 to simultaneously display the N patterns which are obtained by the route acquisition section 9. Then, the input detection device 1 becomes in the standby state until a predetermined time period T₃ elapses (Step S40). After the predetermined time period T₃ elapses, the route switching section 11 selects the one of the N patterns, which is in the selected state, as a pattern to be inputted (Step S41). Next, the route switching section 12 determines whether or not the input section accepts, from the user, an entering operation causing an end of the selection (Step S42). In a case where the route switching section 12 determines that the input section 4 accepts the entering operation causing the end of the selection, the route switching section 11 terminates the selection operation. When the selection operation is terminated, the one of the N patterns is ultimately selected as the input information, which one of the N patterns is in the selected state when the selection operation is terminated (Step S44). In a case where the route switching section 12 determines that there is no entering operation causing the end of the selection, the route switching section 12 switches over the one of the N patterns, which is in the selected state, to another one of the N patterns so that the another one of the N patterns is in the selected state (Step S43). Then, the input detection device 1 becomes in the standby state again until the predetermined time period T₃ elapses. After that, the route switching section 12 determines whether or not the input section 4 accepts the entering operation causing the end of the selection.

In the manner described above, the route switching section 12 sequentially switches over the one of the plurality of items, which is in the selected state, to another one of the plurality of items one by one so that the another one of the plurality of items is in the selected state, until the input section 4 accepts the user's entering operation causing the end of the selection. In a case where (i) each of the N patterns has been sequentially displayed in the selected state, and (ii) for each of the N patterns, the input detection device 1 has been in the standby state for the predetermined time period T₃, the route switching section 12 returns to the initial step, and then repeats the process described above.

### (Display Example for Route Search)

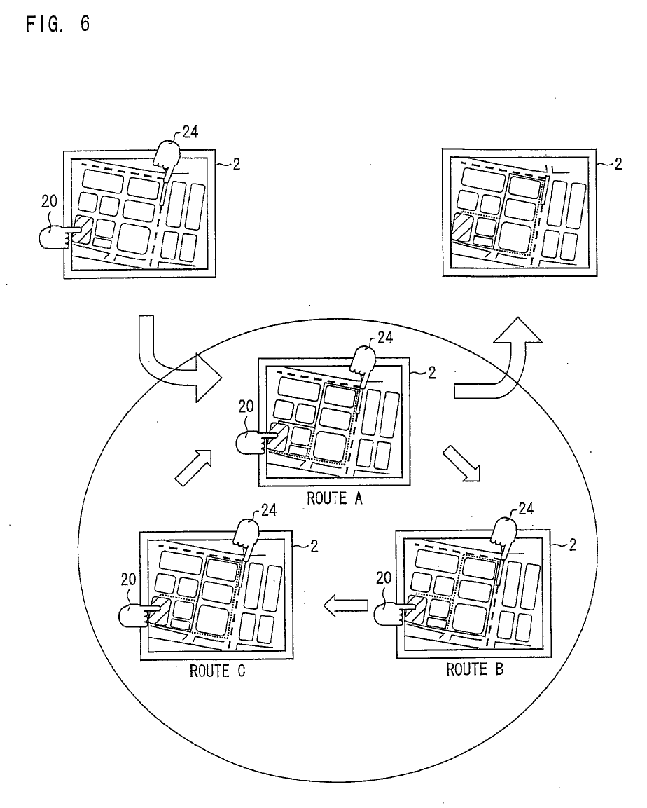

Next, the following description deals with how the user carries out the entering operation with respect to the input detection device 1 in a case where two points are entered, with reference to FIGS. 6 through 8.

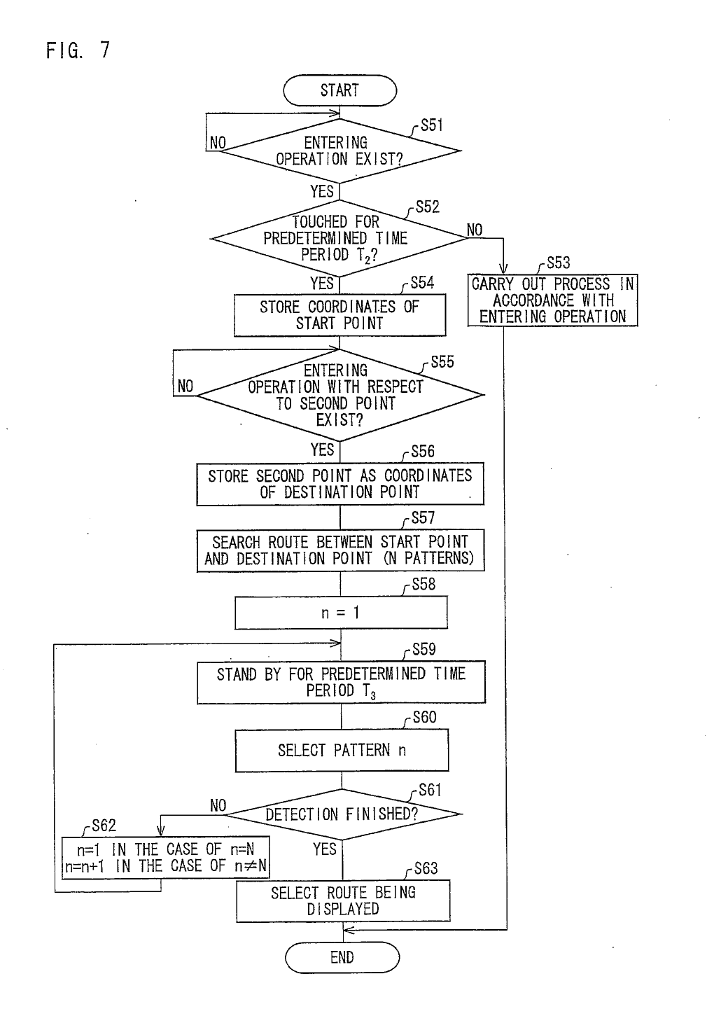

FIG. 6 is a view illustrating how the user operates the input detection device 1 and FIG. 7 is a flowchart showing how the input detection device 1 operates, in a case of designating two points on a map displayed on the display 2 so as to search a route between the two points.

The user touches, via the touch panel 3, first and second points on the map displayed on the display 2 with the finger 20 and a finger 24, respectively. In a case where the touch panel 3 has been touched by either the fingers 20 or 24 for the predetermined time period T₂ or longer, the display 2 displays a plurality of routes (Routes A through C), each connecting the first and second points. Note that one of the first and second points which is first touched by the user is assumed to be a start point, and the other is assumed to be a destination point.

Note that one of the plurality of routes (e.g. Route A) is in a selected state. In the present embodiment, the one of the plurality of routes, which is in the selected state, is displayed in full line on the display screen 2, whereas each of the other(s) of the plurality of routes is displayed in dotted line. How to show which one of the plurality of routes is in the selected state is not limited to this. The one of the plurality of routes, which is in the selected state, can be displayed in any way, provided that it can be recognized by the user (e.g. the route which is in the selected state is displayed in a color different from the other(s) of the plurality of routes).

In a case where the fingers 20 and 24, and the touch panel 3 have been in contact with each other for the predetermined time period T₃, the route which is in the selected state is switched over from Route A to Route B. Further, in a case where the fingers 20 and 24, and the touch panel 3 have been in contact with each other for another predetermined time period T₃, the route which is in the selected state is switched over from Route B to Route C. Furthermore, the fingers 20 and 24, and the touch panel 3 have been in contact with each other for still another predetermined time period T₃, the route which is in the selected state is switched over from Route C to Route A. The switchovers are repeated until the user detaches the fingers 20 and 24 from the touch panel 3.

Here, for example, in a case where the user detaches the fingers 20 and 24 from the touch panel 3 while Route C is in the selected state, Route C is ultimately selected as the input information. In this case, a process in accordance with the input information is carried out. For example, it is possible to cause the display 2 to display (i) Route C only, or (ii) Route C and information related to Route C, such as a distance of Route C, a time period necessary for Route C, etc.

In the present embodiment, the input detection device 1 keeps carrying out the switchover process of the selected state as long as the fingers 20 and 24, and the touch panel 3 are in contact with each other. Note, however, that the present invention is not limited to this. It is possible to arrange such that the input detection device 1 keeps carrying out the switchover process of the selected state even after one of the fingers 20 and 24 is no longer in contact with the touch panel 3.

### (Route Searching Process)

Next, the following description deals with how the input detection device 1 carries out a route searching process when the input detection device 1 accepts the user's entering operation illustrated in FIG. 6, with reference to FIG. 7.

The input section 4 accepts an input signal from the touch panel 3, which input signal is generated in response to the user's entering operation (Step S51). The input section 4 determines whether or not the finger 20 and the touch panel 3 have been in contact with each other for the predetermined time period T₂ or longer (Step S52). In a case where the input section 4 determines that the time period during which the finger 20 and the touch panel 3 have been in contact with each other is less than the predetermined time period T₂, the input section 4 determines the entering operation as a normal entering operation. In this case, the input detection device 1 carries out a process in accordance with the entering operation (Step S53). On the other hand, in a case where the input section 4 determines that the finger 20 and the touch panel 3 have been in contact with each other for the predetermined time period T₂ or longer, the coordinate detection section 7 (i) detects position coordinates of a position on the touch panel 3 where the user touches with the finger 20, and (ii) stores the position coordinates as position coordinates of the start point (Step S54). Next, the coordinate detection section 7 determines whether or not there is another entering operation with respect to a second point (Step S55). In a case where the input section 4 accepts the entering operation with respect to the second point, the coordinate detection section 7 (i) detects position coordinates of the second point, and (ii) stores the position coordinates as the position coordinates of the destination point (Step S56). Upon detection of the position coordinates of the start and destination points, the route acquisition section 9 obtains, by use of a predetermined algorithm, from the pieces of data stored in the database 10, N patterns of route each connecting the start point and the destination point to each other (Step S57). The route switching section 12 causes one of the N patterns of route to be in the selected state (Step S58). The display section 5 causes the display 2 to simultaneously display the N patterns of route, obtained by the route acquisition section 9, so that the user can recognize the one of the N patterns of route, which is in the selected state, among the N patterns of route. After that, the input detection device 1 becomes in the standby state until the predetermined time period T₃ elapses (Step S59). After the predetermined time period T₃ elapses, the route switching section 11 selects, as the route to be inputted, the one of the N patterns of route, which is in the selected state (Step S60). Then, the route switching section 12 determines whether or not the input section 4 accepts, from the user, the entering operation causing the end of the selection (Step S61). In a case where the route switching section 12 determines that the input section 4 accepts the entering operation causing the end of the selection, the route switching section 12 terminates the selection operation. When the selection operation is terminated, the one of the N patterns of route is ultimately selected as the input information, which one of the N patterns of route is in the selected state when the selection operation is terminated (Step S63). In a case where the route switching section 12 determines in Step S61 that there is no entering operation causing the end of the selection, the route switching section 12 switches over the one of the N patterns of route, which is in the selected state, to another one of the N patterns of route so that the another one of the N patterns is in the selected state (Step S62). Then, the input detection device 1 becomes in the standby state again until the predetermined time period T₃ elapses. After that, the route switching section 12 determines whether or not the input section 4 accepts the entering operation causing the end of the selection. In the manner described above, the route switching section 12 sequentially switches over the one of the plurality of items, which is in the selected state, to another one of the plurality of items one by one so that the another one of the plurality of items is in the selected state, until the input section 4 accepts the entering operation causing the end of the selection. In a case where (i) each of the N patterns of route has been sequentially displayed in the selected state, and (ii) for each of the N patterns of route, the input detection device 1 has been in the standby state for the predetermined time period T₃, the route switching section 12 returns to the initial step, and repeats the process described above.

### (Route Search: Another Display Example)

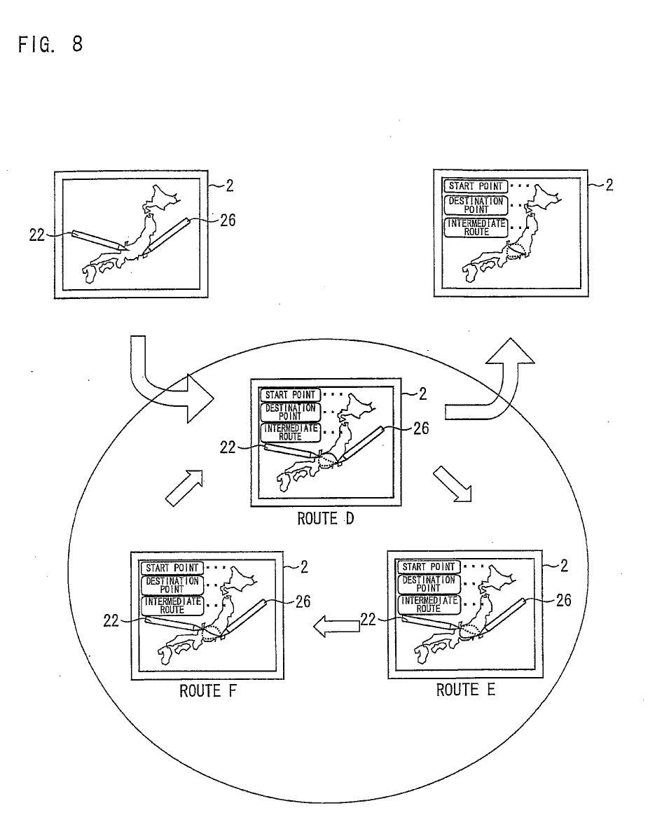

FIG. 8 is a view illustrating how the user carries out the entering operation in a case where the display 2 displays a map showing a larger area as compared with that of the embodiment of FIG. 6. The present embodiment is the same as the embodiment illustrated in FIG. 6, except that the user touches the touch panel 3 with the pen 22 and a pen 26 in place of the fingers 20 and 24. Displayed information includes not only a plurality of routes (Routes D, E, and F) connecting two points to each other, but also a place name or an area name of a start point/destination point, information on intermediate areas in the plurality of routes, information on intermediate means, and the like. Further, In addition to these, it is also possible to cause the display 2 to also display other related information, such as information on a time period necessary for each of the routes, and information on cost necessary for each of the routes.

### (Route Search: Use of GPS)

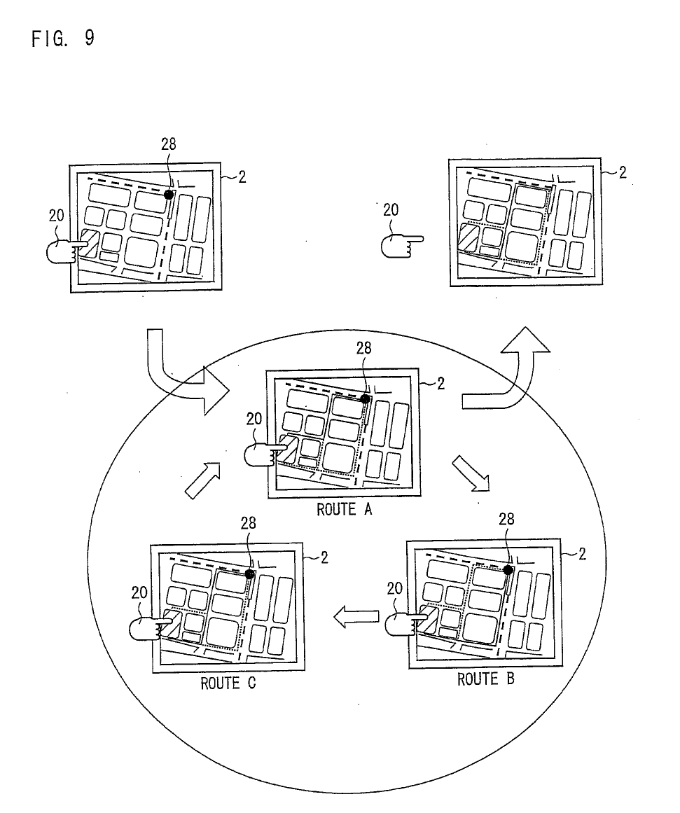

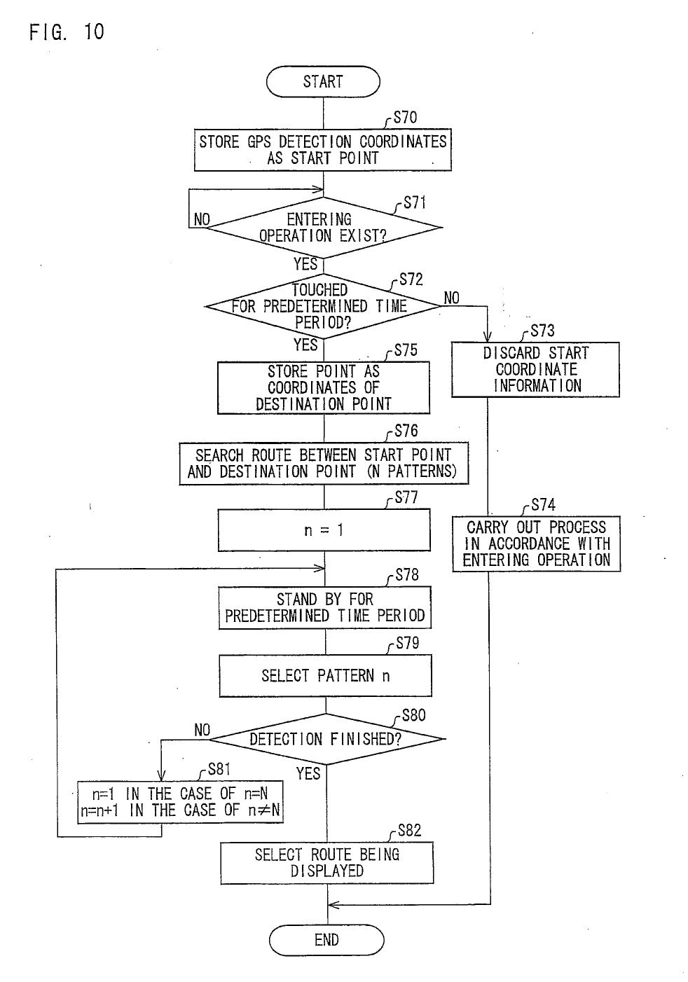

Next, the following description deals with how the input detection device 1 is operated when the user enters a single input point, with reference to FIGS. 9 and 10.

FIG. 9 is a view illustrating how the user carries out the entering operation by designating a single point on a map displayed on the display 2 so as to search a route between the point thus designated and a point indicating a current position of the input detection device 1. Further, FIG. 10 is a flowchart showing how the input detection device 1 is operated by the entering operation described above.

The user touches, with the finger 20, a first point on the map displayed on the display 2 via the touch panel 3 (see FIG. 9). Here, the input detection device 1 obtains information indicating the current position of the input detection device 1 from a GPS satellite via a communication section (not illustrated). In FIG. 9, the current position of the input detection device 1 is displayed on the display 2 as a point 28.

In a case where the finger 20 of the user and the touch panel 3 have been in contact with each other for a predetermined time period or longer, a plurality of routes (Routes A, B, and C), each connecting the first and second points to each other, are displayed on the display 2. Here, the current position of the input detection device 1 is determined as the start point, while the position on the touch panel 3, which position is touched by the user with the finger 20, is determined as the destination point.

Further, one of the plurality of routes thus displayed is in the selected state (e.g. Route A). In the present embodiment, the one of the plurality of routes, which is in the selected state, is displayed on the display 2 in full line, whereas the other routes among the plurality of routes are displayed in dotted line. Note that how to show which one of the plurality of routes is in the selected state is not limited to this. The one of the plurality of routes, which is in the selected state, can be displayed in any way provided that the user can recognize the one of the plurality of routes, which is in the selected state (e.g. the route in the selected state is displayed in a color which is different from the other routes).

In a case where the finger 20 and the touch panel 3 have been in contact with each other for a predetermined time period, the route which is in the selected state is switched over from Route A to Route B. Further, in a case where the finger 20 and the touch panel 3 have been in contact with each other for another predetermined time period T₃, the route which is in the selected state is switched over from Route B to Route C. Furthermore, in a case where the finger 20 and the touch panel 3 have been in contact with each other for further another predetermined time period, the route which is in the selected state is switched over from Route C to Route A. The switchovers are repeated until the user detaches the finger 20 from the touch panel 3.

Here, for example, in a case where the user detaches the finger 20 from the touch panel 3 while Route C is in the selected state, Route C is ultimately selected as the input information. In this case, a process in accordance with the input information is carried out. For example, it is possible to cause the display 2 to display (i) Route C only, or (ii) Route C and information related to Route C, such as a distance of Route C, a time period necessary for Route C, etc.

### (Route Search Process)

Next, the following description deals with how the input detection device 1 selects a route when the input detection device 1 accepts the entering operation illustrated in FIG. 9, with reference to FIG. 10.

First, the input section (not illustrated) of the input detection device 1 stores, in a memory, GPS detection coordinates as a start point (start coordinate information) (Step S71). The input section 4 accepts an input signal from the touch panel 3, which input signal is generated in response to the user's entering operation (Step S72). The input section 4 determines whether or not the finger 20 and the touch panel 3 have been in contact with each other for a predetermined time period or longer (Step S73). In a case where the time period during which the finger 20 and the touch panel 3 have been in contact with each other is less than the predetermined time period, (i) the input section 4 determines the entering operation as a normal entering operation, (ii) the input detection device 1 discards the start coordinate information stored in the memory (Step S74), and (iii) the input detection device 1 carries out a process in accordance with the entering operation (Step S53).

On the other hand, in a case where the input section 4 determines that the finger 20 and the touch panel 3 have been in contact with each other for the predetermined time period or longer, the coordinate detection section 7 (i) detects position coordinates of a position on the touch panel 3 where the user touches with the finger 20, and (ii) stores the position coordinates as the position coordinates of the destination point (Step S75).

The process from Step S76 to S82 is basically the same as the process from Step S57 to Step S63 shown in FIG. 7, so that detailed explanations of Steps S76 through S82 are omitted here.

As described above, the input detection device 1 can carry out the route search process for a route between two points even if the user touches only a single point on the touch panel 3. Further, the input detection device 1 displays a plurality of routes thus searched in such a manner that while the finger 20 and the touch panel 3 are in contact with each other, (i) one of the plurality of routes is displayed in a different display state from those of the other one(s) of the plurality of routes, and (ii) the one of the plurality of routes, which is displayed in the display state, is sequentially switched over to another one of the plurality of routes one by one so that the another one of the plurality of routes is displayed in the display state. This allows the user to select a desirable route with a simple operation.

The present invention is not limited to the description of the embodiments above, but may be altered by a skilled person within the scope of the claims. An embodiment based on a proper combination of technical means disclosed in different embodiments is encompassed in the technical scope of the present invention.

In the input detection device 1, the touch panel 3 can be provided on the display 2. Alternatively, the touch panel 3 and the display 2 can be formed integral with each other. In other words, an arrangement for realizing a function of the touch panel 3 can be included inside the display 2.

The input detection device 1 can include a plurality of displays 2 and a plurality of touch panels 3. For example, the input detection device 1 can be a two-screen personal digital assistant including two displays 2, to which two touch panels 3 are attached, respectively.

### (Program and Storage Medium)

Each of the blocks of the input detection device 1 can be constituted by a hardware logic, or by software by use of a CPU as described below.

That is, the input detection device 1 includes: the CPU (central processing unit) which executes an instruction of a program realizing each of the functions described above; a ROM (read only memory) in which the program is stored; an RAM (random access memory) which develops the program; a storage device (storage medium), such as a memory, in which the program and various kinds of data are stored; and the like. Further, the object of the present invention can be achieved in the following manner: (i) a storage medium for computer-readably storing a program code (an execute form program, intermediate code program, or source program) of a program of the input detection device 1, which is software for implementing the aforementioned functions, is provided to the input detection device 1, and (ii) a computer (or a CPU or a MPU) of the input detection device 1 reads out the program code stored in the storage medium so as to execute the program.

Examples of the storage medium encompass: tapes, such as magnetic tapes and cassette tapes; disks including magnetic disks, such as floppy disks (registered trademark) and hard disks, and optical disks, such as CD-ROMs, magnetic optical disks (MOs), mini disks (MDs), digital video disks (DVDs), and CD-Rs; cards, such as IC cards (including memory cards) and optical cards; and semiconductor memories, such as mask ROMs, EPROMs, EEPROMs, and flash ROMs.

Further, the input detection device 1 can be made connectable to a communication network, and the program code can be supplied via the communication network. The communication networks are not limited to specific means. Examples of the communication network encompass the Internet, an intranet, an extranet, a LAN, an ISDN, a VAN, a CATV communication network, a virtual private network, a telephone line network, a mobile communication network, a satellite communication network, and the like. Furthermore, a transmission medium constituting the communication network is not particularly limited. Specifically, it is possible to use a wired line such as a line in compliance with an IEEE1394 standard, a USB line, a power line, a cable TV line, a telephone line, an ADSL line, and the like, as the transmission medium. Moreover, it is possible to use (i) a wireless line utilizing an infrared ray used in IrDA and a remote controller, (ii) a wireless line which is in compliance with a Bluetooth standard (registered trademark) or an IEEE802.11 wireless standard, and (iii) a wireless line utilizing an HDR, a mobile phone network, a satellite line, a terrestrial digital network, and the like, as the transmission medium. Note that, the present invention can be realized by a computer data signal which is realized by electronic transmission of the program code and which is embedded in a carrier wave.

The present invention can be realized in accordance with the following arrangements.

The input detection device of the present invention preferably further includes coordinate detection means for finding coordinates of a position detected by the input detection means, the display means causing the display to display the plurality of predetermined items in accordance with the coordinates thus found.

According to the arrangement, it is possible to display the plurality of predetermined items in various ways, for example. For example, in a case where the coordinates thus detected indicates a certain building on the map information, it is possible to cause the display to display a plurality of names of stores in the building, as the plurality of predetermined items.

Further, in the input detection device of the present invention, the display is preferably a multipoint detection display, the input detection means preferably simultaneously detects a plurality of touches, made by the user, on the touch panel, and the display means preferably causes the display to display the plurality of predetermined items in accordance with the plurality of touches thus detected.

According to the arrangement, it is possible to provide a plurality of items on the basis of a relationship between the plurality of points. Therefore, the user can obtain more various information. This allows the user to, for example, (i) search a plurality of courses (routes) between two points, and also (ii) obtain information related to each of the plurality of routes.

Furthermore, the input detection device of the present invention preferably further includes region recognition means for recognizing a size of a region on the touch panel, which region is touched by the user, the display means causing the display to display the plurality of predetermined items in accordance with the size of the region.

According to the arrangement, in a case where the user uses an object whose area to be in contact with the touch panel is relatively small, the input detection device can display a plurality of items in accordance with such a small area where the object and the touch panel are in contact with each other. On the other hand, in a case where the user uses another object whose area to be in contact with the touch panel is relatively large, the input detection device can display plurality of items in accordance with such a large area where the another object and the touch panel are in contact with each other. In other words, in a case where the user touches a single point with a first object, and then changes the object to second object, and touches substantially the same single point with the second object, the plurality of items displayed by the touching with the use of the first object can be different from those displayed by the touching with the use of the second object. This enables the user to cause the display to display, in accordance with various situations, a plurality of items which meet user's demand more suitably.

Moreover, in the input detection device of the present invention, the display means preferably causes the display to display predetermined information in accordance with the one of the plurality of predetermined items thus selected.

According to the arrangement, it is possible for the user to obtain desired information with a simple operation.

Further, in the input detection device of the present invention, in addition to the arrangement described above, the touch panel is preferably a photo-detection touch panel.

Note that in the present specification, the “photo-detection touch panel” means a touch panel in which a photodetector is provided, and which recognizes input information, entered by the user, by detecting incident light on the touch panel.

According to the arrangement, it is possible to increase accuracy of the touch panel without a decrease in display quality of a display device. This allows the display device to display, more appropriately, a plurality of items in accordance with a position of a region where an object and the touch panel are in contact with each other. Further, according to the arrangement, it becomes possible to simultaneously detect two or more input points. This allows the input detection device to be applicable to a search for a route between two points, and the like.

Further, the input detection device can be realized by a computer. In this case, the scope of the present invention includes: a program for realizing the input detection device on the computer by causing the computer to functioning as each of the means described above; and a computer-readable storage medium in which the program is stored.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is applicable to a device including a touch panel. Particularly, the present invention is suitably applicable to a mobile phone terminal, a personal digital assistant (PDA), a portable media player (PMP), a digital camera, and a car navigation device (system).

### REFERENCE SIGNS LIST

1: Input detection device
2: Display
3: Touch panel
4: Input section (selection means)
5: Display section (display means)
6: Region recognition section (region recognition means)
7: Coordinate detection section (coordinate detection means)
8: Item acquisition section
9: Route acquisition section
10: Database
11: Item switching section
12: Route switching section
20, 24: Finger
22, 26: Pen

1. An input detection device, comprising:
a display;
a touch panel;
input detection means for detecting a touch made by a user with respect to the touch panel;
display means for, while the input detection means is detecting the touch, (i) causing the display to simultaneously display a plurality of predetermined items, (ii) causing the display to simultaneously display one of the plurality of predetermined items in a different display state from those of the other one(s) of the plurality of predetermined items, and (iii) sequentially switching over the one of the plurality of predetermined items, which is displayed in the display state, to another one of the plurality of predetermined items at predetermined intervals so that the another one of the plurality of predetermined items is displayed in the display state; and
selection means for selecting the one of the plurality of predetermined items, which is displayed in the display state when the input detection means finishes the detecting of the touch.

2. The input detection device as set forth in claim 1, further comprising:
coordinate detection means for finding coordinates of a position detected by the input detection means,
the display means causing the display to display the plurality of predeteimined items in accordance with the coordinates thus found.

3. The input detection device as set forth in claim 1, wherein:
the touch panel is a multipoint detection touch panel;
the input detection means simultaneously detects a plurality of touches, made by the user, on the touch panel; and
the display means causes the display to display the plurality of predetermined items in accordance with the plurality of touches thus detected.

4. The input detection device as set forth in claim 1, further comprising:
region recognition means for recognizing a size of a region on the touch panel, which region is touched by the user,
the display means causing the display to display the plurality of predetermined items in accordance with the size of the region.

5. The input detection device as set forth in claim 1, wherein:
the display means causes the display to display predetermined information in accordance with the one of the plurality of predetermined items thus selected.

6. The input detection device as set forth in claim 3, wherein:
the display means causes the display to display predetermined course information in accordance with the one of the plurality of predetermined items thus selected.

7. The input detection device as set forth in claim 1, wherein:
the touch panel is a photo-detection touch panel.

8. The input detection device as set forth in claim 1, wherein:
the display is a liquid crystal display.

9. The input detection device as set forth in claim 1, wherein:
the input detection device is a personal digital assistant or a mobile phone terminal.

10. An input detection method executed in an input detection device which includes a display and a touch panel,
said input detection method comprising the steps of:
(a) detecting a touch made by a user with respect to the touch panel;
(b) while the input detection means is detecting the touch, (i) causing the display to simultaneously display a plurality of predetermined items, (ii) causing the display to simultaneously display one of the plurality of predetermined items in a different display state from those of the other one(s) of the plurality of predetermined items, and (iii) sequentially switching over the one of the plurality of predetermined items, which is displayed in the display state, to another one of the plurality of predetermined items at predetermined intervals so that the another one of the plurality of predetermined items is displayed in the display state; and
(c) selecting the one of the plurality of predetermined items, which is displayed in the display state when the input detection means finishes the detecting of the touch.

11. A program for causing an input detection device as set forth in claim 1 to operate,
the program causing a computer to function as each of said means.

12. A computer-readable storage medium in which a program as set forth in claim 11 is stored.
